(19) United States
(12) Patent Application Publication
(10) Pub. No.: US 2015/0248229 A1
(43) Pub. Date: Sep. 3, 2015

(54) ELECTRONIC DEVICES AND METHODS FOR CONTROLLING USER INTERFACE

(71) Applicant: Acer Incorporated, New Taipei City (TW)

(72) Inventor: Yu-Chun Chen, New Taipei City (TW)

(21) Appl. No.: 14/450,431

(22) Filed: Aug. 4, 2014

(30) Foreign Application Priority Data
Mar. 3, 2014 (TW) 103106966

(51) Int. Cl. G06F 3/0484; G06F 3/0486

(52) U.S. Cl. CPC G06F 3/04847; G06F 3/0486; G06F 3/04842

(57) ABSTRACT

An electronic device includes a display unit, a touch-sensing module and a processing unit. The display unit displays a user interface. The user interface includes a first seek bar and a second seek bar. The touch-sensing module senses a first dragging event and a second dragging event of the first seek bar, and a third dragging event of the second seek bar corresponding to a touching object. The processing unit implements the user interface. Furthermore, the first seek bar is disabled and the second seek bar is enabled by the processing unit according to a first distance of the first dragging event and a second distance of the second dragging event when the touching object remains in a predetermined area for a predetermined period. The file is enabled according to the final position of the third dragging event.

### CROSS REFERENCE TO RELATED APPLICATIONS

This Application claims priority of Taiwan Patent Application No. 103106966, filed on Mar. 3, 2014, the entirety of which is incorporated by reference herein.

### BACKGROUND OF THE INVENTION

1. Field of the Invention

The application relates in general to an electronic device and a method for controlling a user interface, and in particular to an electronic device and a user-interface control method for enabling another seek bar for accurate control.

2. Description of the Related Art

These days, due to electronic devices having been rapidly developed, a user can browse files and run applications using an electronic device in his or her daily life. When the user browses large amounts of files or run some specific applications by dragging an icon on a touch-enabled screen, the size of the touching object might have an influence on the accuracy of the operation. For example, when the user wants to perform a dragging motion within a small area using a large touching object, it may cause an inconvenience during the operating procedure. Thus, how to provide a better operation for a user in that situation is the problem which needs to be solved immediately.

### BRIEF SUMMARY OF INVENTION

An embodiment of the invention provides an electronic device that includes a display unit, a touch-sensing module and a processing unit. The display unit displays a user interface. The user interface includes a first seek bar and a second seek bar. The touch-sensing module is arranged to sense a first dragging event and a second dragging event on the first seek bar, and a third dragging event on the second seek bar corresponding to a touching object. The first dragging event moves along a first direction, and the second dragging event moves along a second direction. The first direction and the second direction are opposite to each other. The processing unit implements the user interface. Furthermore, the first seek bar is disabled and the second seek bar is enabled by the processing unit according to the first distance of the first dragging event and the second distance of the second dragging event, when the touching object remains in a predetermined area for a predetermined period. The file is enabled according to the final position of the third dragging event. The operating range of the second seek bar is displayed in a predetermined proportion according to the first distance and the second distance.

Another embodiment of the invention provides a method for controlling the user interface, which is adapted to an electronic device, the steps comprising: implementing a user interface including a first seek bar and a second seek bar; sensing a first dragging event of a first seek bar and a second dragging event of a second seek bar corresponding to a touching object, and the first dragging event moves along a first direction and the second dragging event moves along a second direction, and the first direction and the second direction are opposite to each other; disabling the first seek bar and enabling the second seek bar according to a first distance of the first dragging event and a second distance of the second dragging event when enabling the first dragging event or the second dragging event and the touching objecting is left in a predetermined area for a predetermined period, further, the operating range of the second bar is displayed in a predetermined proportion according to the first distance and the second distance; sensing a third dragging event of the second seek bar corresponding to the touching object; and enabling the file according to the final position of the third dragging event.

### BRIEF DESCRIPTION OF DRAWINGS

The invention can be more fully understood by reading the subsequent detailed description and examples with references made to the accompanying drawings, wherein:

FIG. 1 is a block diagram of an electronic device in accordance with an embodiment of the invention;

FIGS. 2A and 2B are schematic diagrams of the operations of a user interface in accordance with an embodiment of the invention;

FIGS. 3A and 3B are schematic diagrams of the operations of a user interface in accordance with another embodiment of the invention;

FIGS. 4A and 4B are schematic diagrams of the operations of a user interface in accordance with another embodiment of the invention;

FIG. 5 is a flow chart of a method for controlling the user interface in accordance with an embodiment of the invention.

### DETAILED DESCRIPTION OF INVENTION

Further areas in which the present devices and methods can be applied will become apparent from the detailed description provided herein. It should be understood that the detailed description and specific examples, while indicating exemplary embodiments of the electronic devices and the method for controlling a user interface, are intended for purposes of illustration only and are not intended to limit the scope of the invention.

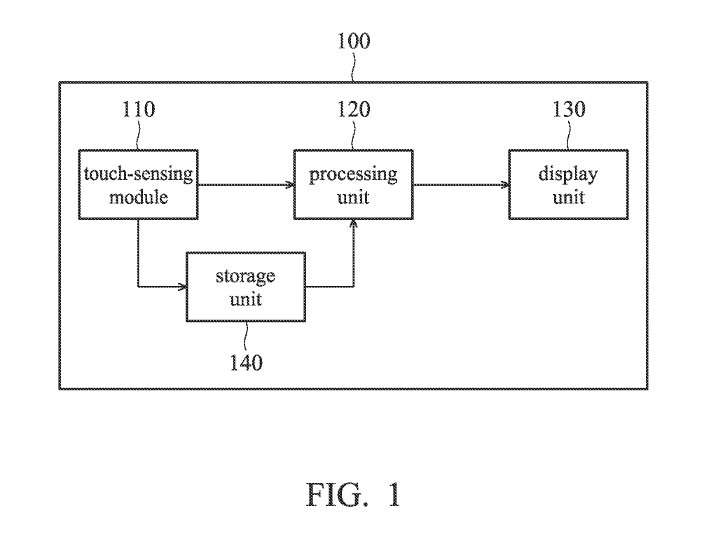

FIG. 1 is a block diagram of an electronic device in accordance with an embodiment of the invention. As shown in FIG. 1, the electronic device 100 includes a touch-sensing module 110, a processing unit 120, a display unit 130, and a storage unit 140. The electronic device 100 can be a personal digital assistant, a mobile phone, a smartphone, a laptop, a tablet PC, or a game device. The touching object can be a finger of the user, stylus, or any object that can enable the touch-sensing electrodes. The first seek bar can be the timeline seek bar of the multimedia player, or the seek bar of the file-browser application. The processing unit 120 implements a user interface. After the first dragging event or the second dragging event is enabled, the processing unit 120 further disables the first seek bar and enables the second seek bar when the touching object is left in a predetermined area for a predetermined period. In addition, the processing unit 120 further enables a file according a final position of the third dragging event. The user interface can be the multimedia application, the applications of the phonebook and e-mail, or the file browser application.

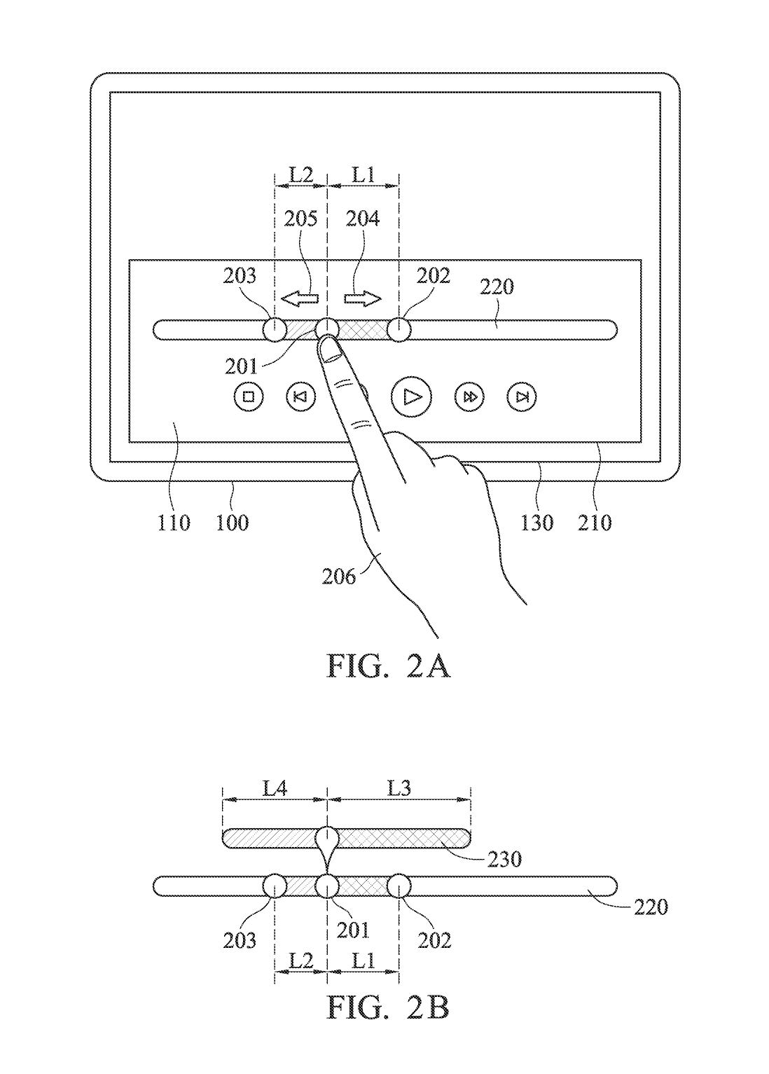

Please refer to FIGS. 2A and 2B. FIGS. 2A and 2B are schematic diagrams of the operations of a user interface in accordance with an embodiment of the invention. As shown in FIG. 2A, the display unit 130 displays a user interface 210. The user interface is a multimedia player, and the first seek bar 220 is the timeline seek bar which is arranged to control the playing of the multimedia application. The touch-sensing module 110 senses the first dragging event or the second dragging event corresponding to the finger 206 of the user when the cursor is moved between the endpoint 202 and the endpoint 203 back and forth by the finger 206, and finally stops at the endpoint 201. The first dragging event is related to the event in which the finger 206 moves on the first seek bar 220 from the endpoint 201 to the endpoint 202 along the first direction 204 for executing a fast forward function. The second dragging event is related to the event in which the finger 206 moves on the first seek bar 220 from the endpoint 201 to the endpoint 203 along the second direction 205 for executing a rewind function. The first direction 204 and the second direction 205 are opposite to each other. The electronic device 100 further includes a storage unit 140 (not shown) which stores the positions of the endpoint 202 and the endpoint 203 for obtaining the first distance L1 between the endpoint 201 and the endpoint 202 and the second distance L2 between the endpoint 201 and the endpoint 203.

Please refer to FIG. 2B. The first seek bar 220 is disabled and the second seek bar 230 is enabled when the finger 206 stops at the position of endpoint 201 and remains in a predetermined area for a predetermined period. Further, the predetermined area is in a predetermined proportion to the width of the touching object. In accordance with the embodiment of the invention, the touching object can be the finger of the user, and the predetermined area can be defined as 1.5 times of the width of the finger, and the predetermined period can be defined as 2 seconds. In should be noted that the width of the predetermined area can be adjusted according to the need of the user due to the size of the touching object not being limited, and the preferred width of the predetermined area is about 1˜1.5 times-width of the finger. In addition, the operating range of the second seek bar 230 is displayed in a first predetermined proportion according to the first distance and the second distance. In accordance with the embodiment of the invention, as shown in FIG. 2B, the operating range of the second seek bar is composed by the third distance L3 and the fourth distance L4, and the third distance L3 is 2 times the first distance L1 and the fourth distance L4 is 2 times the second distance L2. However, the operating range can be adjusted according to the needs of the user. It should be noted that the operating range of the second seek bar 230 is not changed even though the length of the second seek bar 230 is 2 times the distance between the endpoint 202 and the endpoint 203. For example, the endpoint 202 and the endpoint 203 correspond to the position of 20 seconds and 40 seconds on the timeline, respectively, and the operating range of the second seek bar 230 is between 20 seconds and 40 seconds.

The touch-sensing module 110 further senses the dragging motion which is the third dragging event of the finger corresponding to the first direction 204 or the second direction 205 after the second seek bar 230 is enabled and before the finger has left the touch-sensing module 110. It should be noted that the operating range of the second seek bar 230 is limited between the endpoint 202 and the endpoint 203 of the first seek bar 220. The processing unit 120 disables the second seek bar 120 when the finger 206 of the user has left the touch-sensing module 110. The multimedia file corresponding to the first seek bar 220 is enabled according to the final position of the second seek bar 230 when the finger 206 has left the touch-sensing module 110. It should be noted that a cursor can be displayed on the first seek bar 220 and the second seek bar 230, and the position of the cursor corresponds to the position of the touching object. In addition, the finger 206 of the user can enable a dragging motion on the second seek bar 230 or in a predetermined area closed to the second seek bar 230, and the touch-sensing module 100 enables the dragging event of the second seek bar 230 according to the dragging motion as described above.

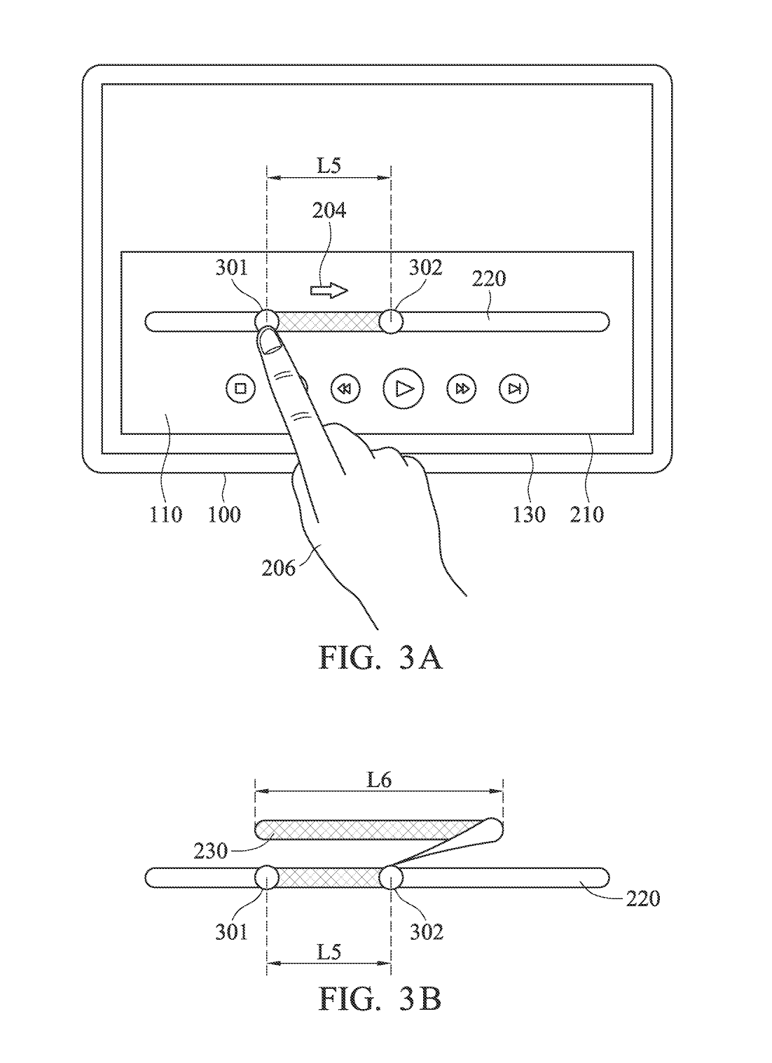

Please refer to FIGS. 3A and 3B. According to another embodiment, as shown in FIG. 3A, when the finger 206 of the user enables a dragging event in single direction on the first seek bar 220 along the first direction 204 from the endpoint 301 to the endpoint 302, and then stays in a predetermined area for a predetermined period, the positions of the endpoint 301 and the endpoint 302 are stored in the storage unit 140, and the first seek bar 220 is disabled and the second seek bar 230 is enabled. The operating range of the second seek bar 230 is displayed in a first predetermined proportion according to the fifth distance L5 between the endpoint 301 and the endpoint 302. According to the embodiment, as shown in FIG. 3B, the operating range of the second seek bar 230 is composed by the sixth distance L6, and the sixth distance L6 is 2 times of the fifth distance L5.

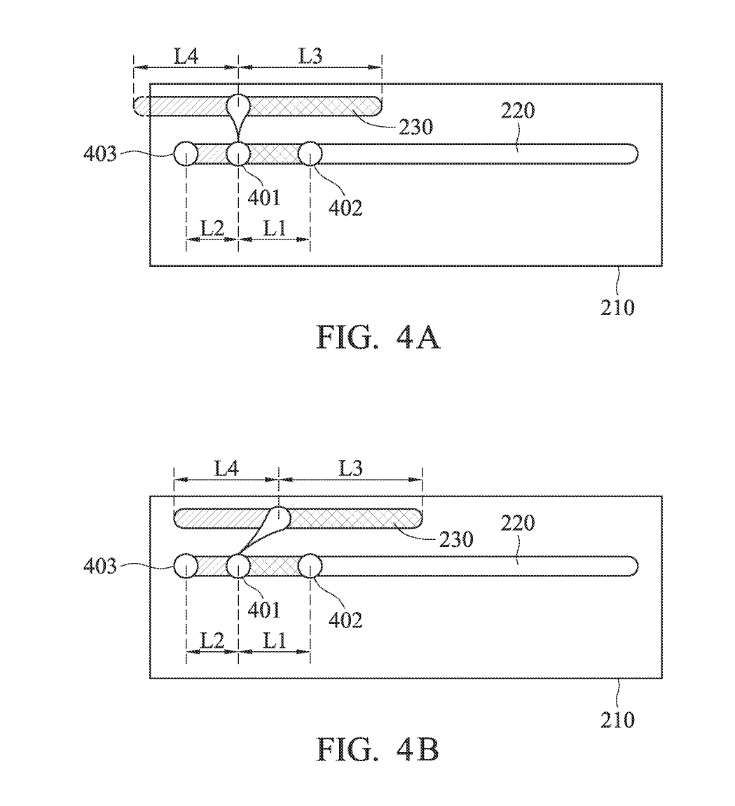

Please refer to FIGS. 4A and 4B. In accordance with an embodiment of the invention, the boundary point of the second seek bar 230 is adjusted according to the position of the finger 206 when the stopping position of the finger 206 of the user is too close to the boundary points of the first seek bar 220. As shown in FIG. 4A, after the second seek bar 230 is enabled, the second seek bar 230 may have the problem of being incompletely displayed when the leftmost endpoint of the second seek bar 230 is over the leftmost endpoint of the first seek bar 220, which is shown as the dotted line on the left side of the second seek bar 230. The leftmost boundary point of the second seek bar 230 will be adjusted by the processing unit 120 to avoid the above situation. As shown in FIG. 4B, the leftmost endpoint of the second seek bar 230 will be adjusted to a position which is aligned with the leftmost endpoint of the first seek bar 220 when the leftmost endpoint of the second seek bar 230 is over the leftmost endpoint of the first seek bar 220. It should be noted that the operating range of the second seek bar 230 will not be changed since the processing unit 120 only adjusts the displayed position of the second seek bar 230.

In accordance with another embodiment of the invention, the user interface can be that of an application, such as a phonebook or e-mail, which has the function of browsing the files. Due to the above applications having the feature of data classification, such as using letters, strokes, annotated sounds, etc., as the basis for classification, when the user enables the second seek bar by the above feature, the operating range of the second bar can be limited to the position of the first seek bar corresponding to the classification of letters, strokes, or annotated sounds. For example, the finger is stopped at the position corresponding to the letter of “C” when the user enables the first seek bar. After the second seek bar is enabled, the operating range of the second seek bar will be limited in the sub classification of the letter of “C” until the second seek bar is disabled.

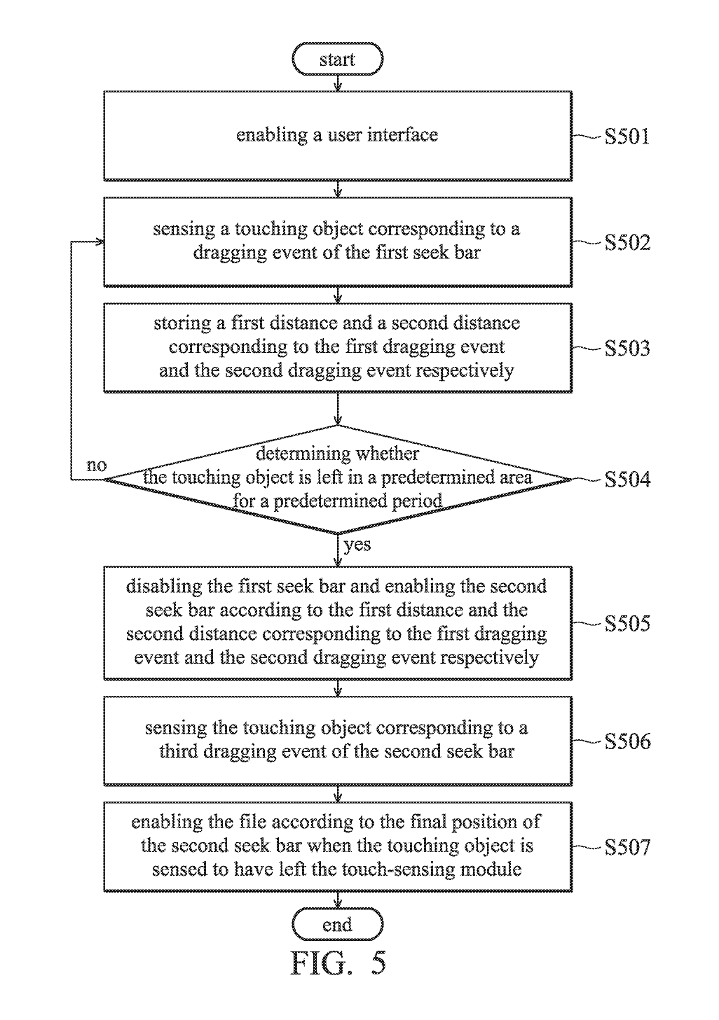

Please refer to FIG. 5 and FIG. 1. FIG. 5 is a flow chart of a method for controlling user interface in accordance with an embodiment of the invention. First, instep S501, the user enables a user interface including a first seek bar. The user interface can be the multimedia application, the applications of the phonebook and e-mail, or the file browser application. In step S502, the touch-sensing module 110 senses a first dragging event or a second dragging event of the first seek bar corresponding to a touching object. The touching object can be a finger of the user, stylus, or any object that can enable the touch sensing electrodes. The first dragging event is determined as the touching object moves along a first direction on the first seek bar, and the second dragging event is determined as the touching object moves along a second direction on the first seek bar, and the first direction and the second direction are opposite to each other. In step S503, the storage unit 140 stores a first distance and a second distance corresponding to the first dragging event and the second dragging event respectively. The first distance is determined as the distance between the final endpoint of the touching object and the previous endpoint corresponding to the first direction, and the second distance is determined as the distance between the final endpoint and the previous endpoint corresponding to the second direction.

Thus, the processing unit 120 determines whether the touching object is left in a predetermined area for a predetermined period (step S504). If the touching object does not remain in the predetermined area for the predetermined period, then the method returns to step S502, and the touch-sensing module 110 senses the first dragging event or the second dragging event of the first seek bar once again. If the touching object remains in a predetermined area for a predetermined period, then the method goes to step S505, and the processing unit 120 disables the first seek bar and enables the second seek bar according to the first distance and the second distance corresponding to the first dragging event and the second dragging event, respectively. The operating range of the second seek bar is displayed in a first predetermined proportion according to the first distance and the second distance. In addition, the operating range of the second bar is limited between the first distance and the second distance of the first seek bar.

It should be noted that the width of the predetermined area can be adjusted according to the need of the user due to the size of the touching object being uncertain, and the preferred width of the predetermined area is about 1˜1.5 times the width of the finger.

After the second seek bar is enabled, the touch-sensing module 110 further senses a third dragging event of the second seek bar corresponding to the touching object (step S506). Finally, the method goes to step S507, and the file is enabled according to the final position of the second seek bar when the touching object is sensed to have left the touch-sensing module 110.

As described above, an embodiment of the invention provides an electronic device and a method for controlling the user interface. The user can make the accurate control or browse a categorized file of a limited range by leaving his or her finger in the predetermined area for the predetermined period, thus enabling another seek bar for a better user experience when the user makes an adjustment to the timeline of a multimedia application or browses a large amount of files using the seek bar.

It will be apparent to those skilled in the art that various modifications and variations can be made to the disclosed structure without departing from the scope or spirit of the invention. In view of the foregoing, it is intended that the present invention covers modifications and variations of this invention, provided they fall within the scope of the following claims and their equivalents.

What is claimed is:

1. An electronic device, comprising:
a display unit, displaying a user interface;
a touch-sensing module, sensing a first dragging event and a second dragging event of a first seek bar, and a third dragging event of a second seek bar corresponding to a touching object, wherein the first dragging event moves along a first direction, and the second dragging event moves along a second direction, and the first direction and the second direction are opposite to each other; and
a processing unit, implementing the user interface, disabling the first seek bar and enabling the second seek bar according to a first distance of the first dragging event and a second distance of the second dragging event when the touching object remains in a predetermined area for a predetermined period, and enabling a file according to the final position of the third dragging event, wherein an operating range of the second seek bar is displayed in a first predetermined proportion according to the first distance and the second distance.

2. The electronic device as claimed in claim 1, wherein the predetermined area is in a second predetermined proportion to a width of the touching object.

3. The electronic device as claimed in claim 1, wherein the user interface is a multimedia application.

4. The electronic device as claimed in claim 3, wherein the user interface is a file browser application.

5. The electronic device as claimed in claim 4, wherein after the second seek bar is enabled, the second seek bar will be disabled when the touch-sensing module detects that the touching object has departed from the second seek bar.

6. A method for displaying a user interface, adapted to an electronic device, comprising:
implementing a user interface including a first seek bar and a second seek bar;
sensing a first dragging event of a first seek bar and a second dragging event of a second seek bar corresponding to a touching object, wherein the first dragging event moves in a first direction and the second dragging event moves in a second direction, and the operating range of the second bar is displayed in a predetermined proportion according to the first distance and the second distance;
disabling the first seek bar and enabling the second seek bar according to a first distance of the first dragging event and a second distance of the second dragging event when enabling the first dragging event or the second dragging event and the touching object is left in a predetermined area for a predetermined period, further, the operating range of the second bar is displayed in a first predetermined proportion according to the first distance and the second distance;
sensing a third dragging event of the second seek bar corresponding to the touching object; and
enabling a file according to the final position of the third dragging event.

7. The method as claimed in claim 6, wherein the predetermined area is in a second predetermined proportion to a width of the touching object.

8. The method as claimed in claim 6, wherein the user interface is a multimedia application.

9. The method as claimed in claim 6, wherein the user interface is a file browser application.

10. The method as claimed in claim 6, wherein after the second seek bar is enabled, the second seek bar will be disabled when sensing that the touching object has departed from the second seek bar.
